(19) United States
(12) Patent Application Publication
(10) Pub. No.: US 2013/0074960 A1
(43) Pub. Date: Mar. 28, 2013

(54) PORTABLE, REFRIGERANT RECOVERY UNIT

(71) Applicants: Gregory S. Sundheim, Englewood, CO (US); Christian L. Pena, Englewood, CO (US)

(72) Inventors: Gregory S. Sundheim, Englewood, CO (US); Christian L. Pena, Englewood, CO (US)

(73) Assignee: Gregory S. Sundheim, Englewood, CO (US)

(21) Appl. No.: 13/240,858

(22) Filed: Sep. 22, 2011

(51) Int. Cl. F15D 1/00

(52) U.S. Cl. 137/565.29; 137/565.01

(57) ABSTRACT

A portable, refrigerant recovery unit for transferring refrigerant from a refrigeration system to a storage tank. The unit includes two, opposed piston heads rigidly attached to respective piston rods that extend along a common fixed axis and are rigidly attached to a scotch yoke arrangement. In operation, incoming refrigerant is simultaneously and continuously directed to the opposing piston heads wherein the forces of the pressurized refrigerant on them counterbalance one another. The flow path of the refrigerant is designed to be isolated from the piston rods and drive mechanism to avoid any exposure to any contaminants in the refrigerant. However, to the extent the undersides of the piston heads and portions of the piston rods may be so exposed, a chamber is provided adjacent each piston underside to capture or collect any contaminants and direct them harmlessly back through one-way exhaust lines into the incoming refrigerant lines.

### BACKGROUND OF THE INVENTION

1. Field of the Invention.

This invention relates to the field of portable, refrigerant recovery units,

2. Discussion of the Background.

Portable, refrigerant recovery units are primarily used to transfer refrigerant from a refrigeration system to a storage tank. In this manner, the refrigerant can be removed from the system and captured in the tank without undesirably escaping into the atmosphere. Needed repairs or other service can then be performed on the system.

Such recovery units face a number of problems in making the transfer of the refrigerant to the storage tank. In particular, the initial pressures of the refrigerant in the system can be quite high (e.g., 100-300 psi or more). These pressures can exert significant forces on the components of the unit including the pistons and drive mechanism. In some cases, the initial force may even be high enough to overpower the drive mechanism of the recovery unit and prevent it from even starting. In nearly all cases, the forces generated by the incoming pressurized refrigerant during at least the early cycles of the recovery operation are quite substantial and can be exerted in impulses or jolts. These forces can easily damage and wear the components of the unit if not properly handled.

In some prior designs, attempts have been made to minimize the forces exerted on the piston by exposing both sides of the head of the piston to the pressurized refrigerant. However, nearly all of these prior designs result in exposing not only the underside of the piston head to the refrigerant but also the piston rod and drive mechanism (e.g., crankshaft). Because the refrigerant typically has oil and other contaminants (e.g., fine metal particles) in it, the exposed piston rod, crankshaft, and other parts of the recovery unit can become prematurely worn and damaged, particularly at their seals and bearings.

In other prior arrangements that do not expose these parts of the unit to the refrigerant, efforts have been tried to minimize the wear and damage to the drive mechanism (e.g., crankshaft bearings) from the refrigerant forces by operating another piston along the crankshaft at 180 degrees out of phase. However, these arrangements still drive the piston rods eccentrically about the axis of the crankshaft and out of alignment with each other. In most cases, they also pivotally mount the piston heads to the piston rods (e.g., with wrist pins). Although the forces of the pressurized refrigerant on the crankshaft are somewhat offset in such arrangements, the eccentrically mounted and unaligned piston rods still apply unbalanced stresses to the crankshaft. Additionally, the forces of the pressurized refrigerant are still borne by the pivot arrangement between the head and rod of each piston. The pivot arrangement in particular can then wear leading to irregular operation of the piston and seal leakage. Eventually, the pivot arrangement may even fail altogether.

With these and other problems in mind, the present invention was developed.

### SUMMARY OF THE INVENTION

This invention involves a portable, refrigerant recovery unit for transferring refrigerant from a refrigeration system to a storage tank. The recovery unit includes two, opposed piston heads rigidly attached to respective piston rods that extend along a common fixed axis. The piston rods in turn are rigidly attached to the yoke member of a scotch yoke arrangement. The scotch yoke arrangement translates rotational motion from a driving mechanism into reciprocal movement of the yoke member and rigidly attached piston rods and piston heads along the common fixed axis.

In operation, incoming refrigerant from the system is simultaneously and continuously directed to the opposing piston heads wherein the forces of the pressurized refrigerant on them counterbalance or neutralize one another. The drive mechanism of the unit can then reciprocate the pistons independently of the size of any forces generated on them by the incoming refrigerant. The flow path of the refrigerant is also designed to be isolated from the piston rods and drive mechanism to avoid any exposure to any contaminants in the refrigerant. However, to the extent the undersides of the piston heads and portions of the piston rods may be so exposed, a chamber is provided adjacent each piston underside to capture or collect any contaminants and direct them harmlessly back through one-way exhaust lines into the incoming refrigerant lines. A single piston embodiment is also disclosed. Details of the scotch yoke arrangement are additionally disclosed including a two-piece slide mechanism mounted about a cylindrical crank pin.

### BRIEF DESCRIPTION OF THE DRAWINGS

FIG. 1 is a perspective view of the portable, refrigerant recovery unit of the present invention.

FIG. 2 illustrates a typical operating arrangement in which the recovery unit is used to transfer refrigerant from a refrigeration system to a storage tank.

FIG. 3 is a schematic showing of part of the operating arrangement of FIG. 2.

FIGS. 4-6 are sequential views of the operation of the opposing pistons of the compressor of the present invention.

FIG. 7 is a view of the pistons at the outset of a hookup to the refrigeration system of FIG. 2 in which the pressures of the refrigeration system and storage tank are being equalized prior to the start up of the compressor.

FIG. 8 is a perspective view of the compressor.

FIG. 9 is a view taken along line 9-9 of FIGS. 6 and 8.

FIG. 10 is an exploded view of the drive mechanism for the compressor.

FIG. 11 is a cross-sectional view of a single piston embodiment of the present invention.

### DETAILED DESCRIPTION OF THE INVENTION

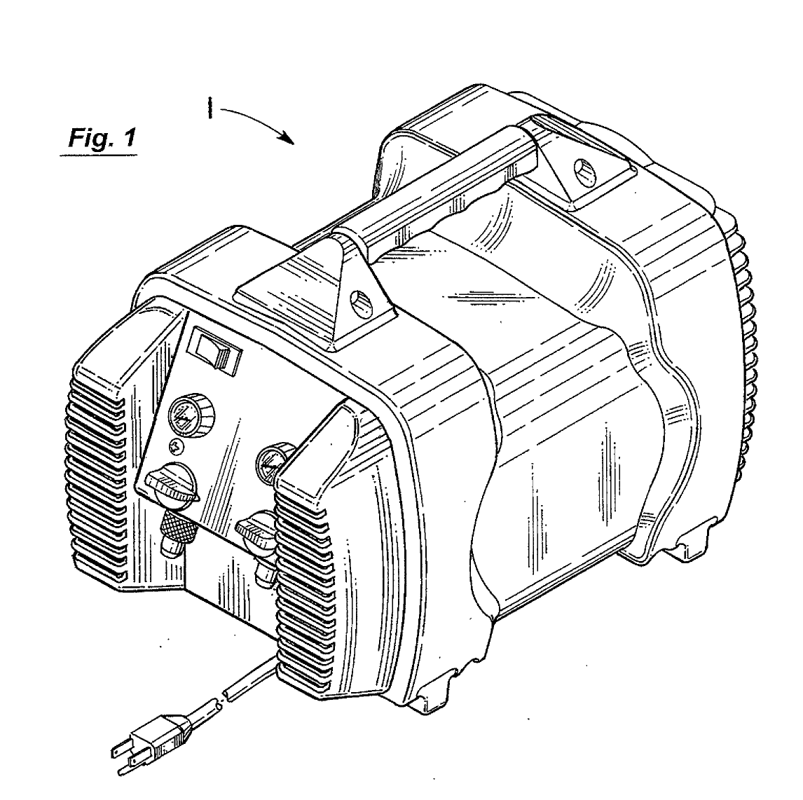

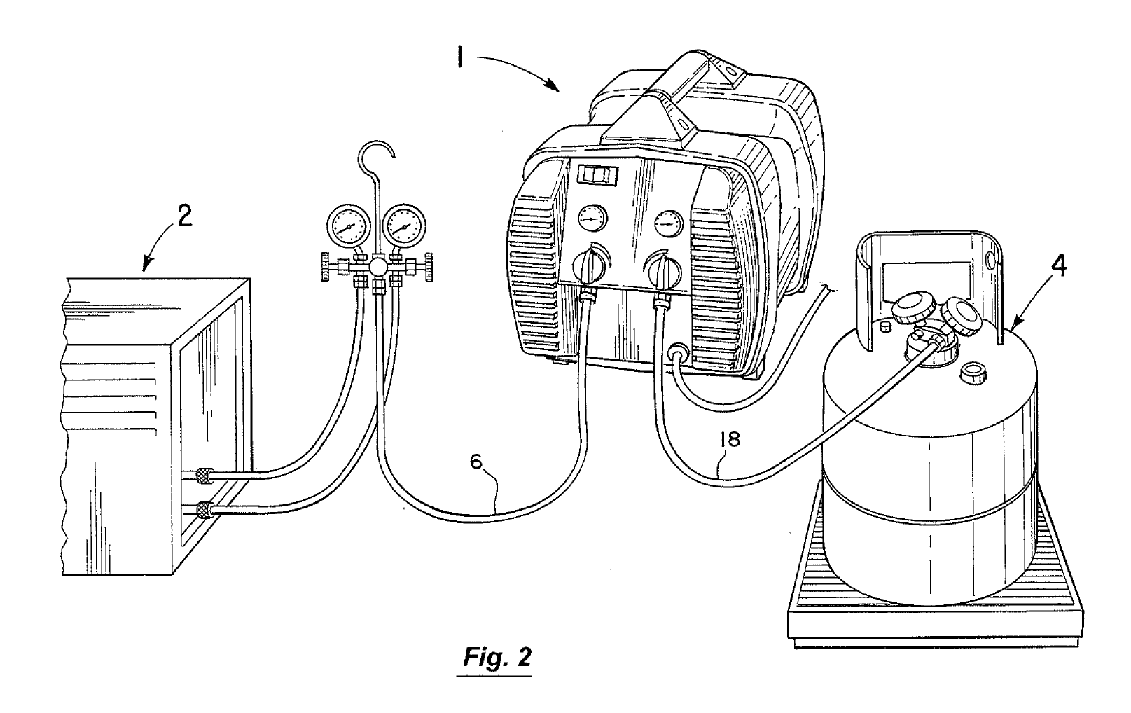

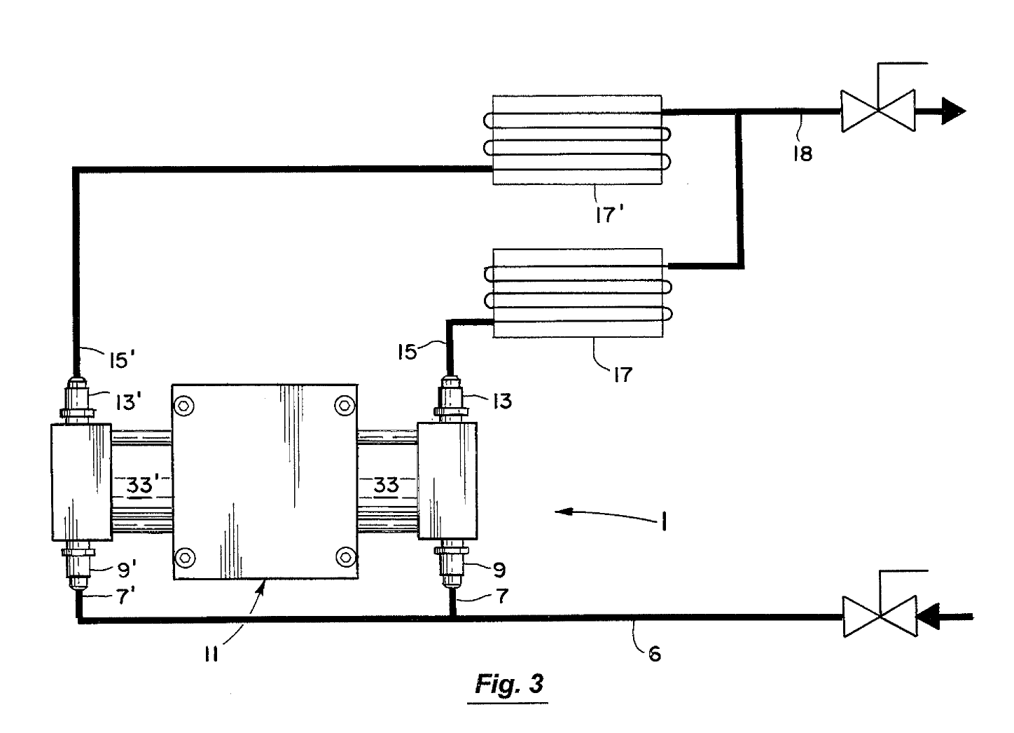

FIG. 1 illustrates the portable, refrigerant recovery unit 1 of the present invention. In a typical operating arrangement as shown in FIG. 2, the unit 1 is used to transfer refrigerant from the refrigeration system 2 to the storage tank 4. This basic operating arrangement is schematically illustrated in FIG. 3. In it, refrigerant from the recovery system 2 of FIG. 2 is being delivered through the line 6 (FIGS. 2 and 3) to the incoming lines 7, 7′ of the recovery unit 1 (FIG. 3). The lines 7,7′ as illustrated are respectively connected to the inlets 9,9′ of the compressor 11 of the recovery unit 1. From the compressor 11 in FIG. 3, the refrigerant is passed through outlets 13,13′ to the lines 15,15′ on which condensers 17,17′ are mounted and then through line 18 to the storage tank 4 of FIG. 2,

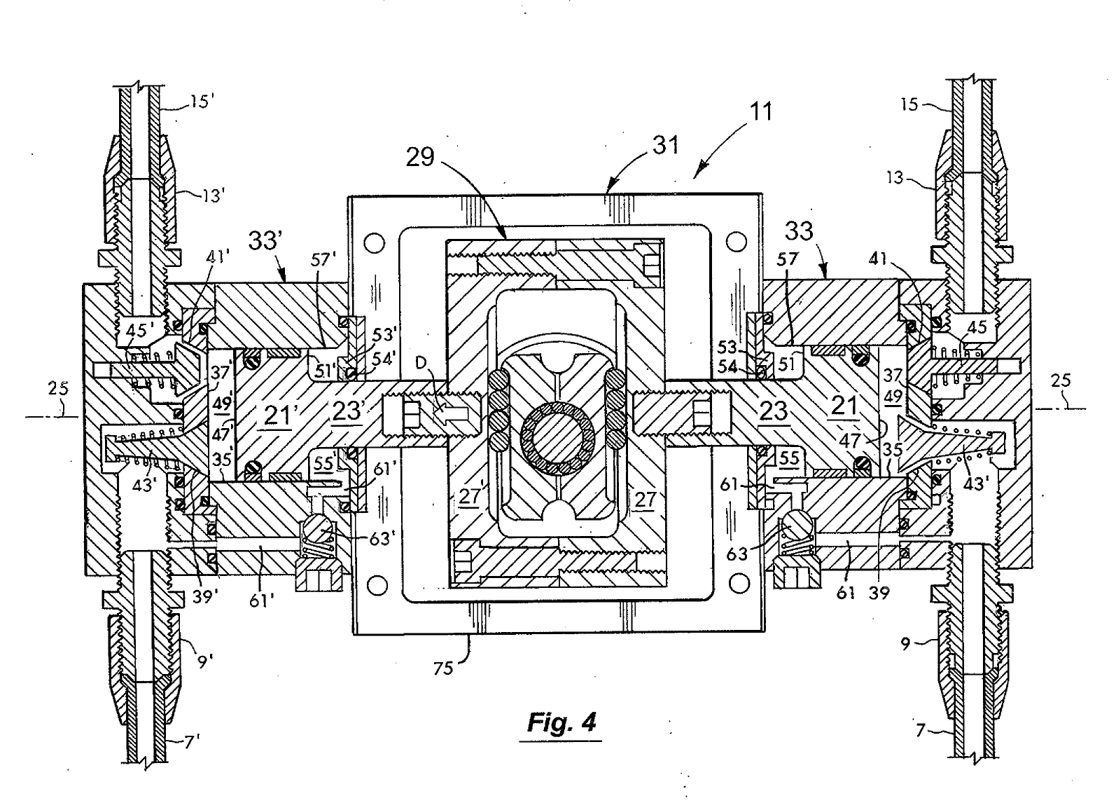

The compressor 11 of the recovery unit 1 as best seen in FIG. 4 has opposing piston heads 21,21′ respectively rigidly attached to piston rods 23,23′. The piston rods 23,23′ in turn extend along a common fixed axis 25 and are rigidly attached to the side pieces 27,27′ of the yoke member 29. The piston rods 23,23′ in FIG. 4 extend in opposite directions from the yoke side pieces 27,27′ along the common fixed axis 25. The yoke member 29 as explained in more detail below is part of a scotch yoke arrangement 31. The scotch yoke arrangement 31 in this regard serves to translate rotational motion from a driving mechanism discussed later into reciprocal movement of the yoke member 29 and rigidly attached piston rods 23,23′ and piston heads 21,21′ along the common fixed axis 25.

Each piston head 21,21′ in FIG. 4 is slidably and sealingly received in a cylinder 33,33′ having an inner, cylindrical side wall with a first portion 35,35′ and an end wall 37,37′. As shown in FIG. 4, each end wall 37,37′ has an inlet 39,39′ and outlet 41,41′ with respective one-way valves 43,43′ and 45,45′ therein. Each piston head 21,21′ in turn has an outer surface 47,47′ opposing the end wall 37,37′ to define a chamber 49,49′ with the end wall 37,37′ and the first side wall portions 35,35′ of each chamber 49,49′. These substantially mirror-image, twin arrangements are preferably identical in size and in particular, the circular areas of the outer surfaces 47,47′ of the piston heads 21,21′ are preferably the same (e.g., about one inch in diameter).

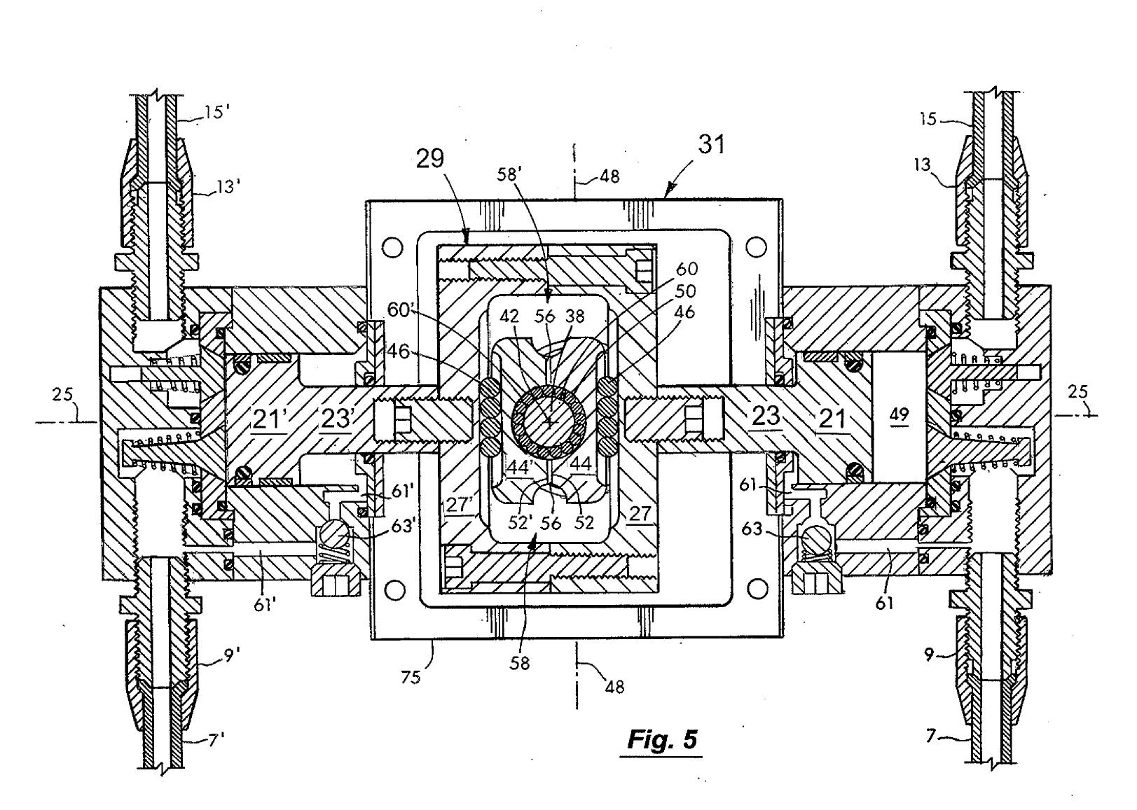

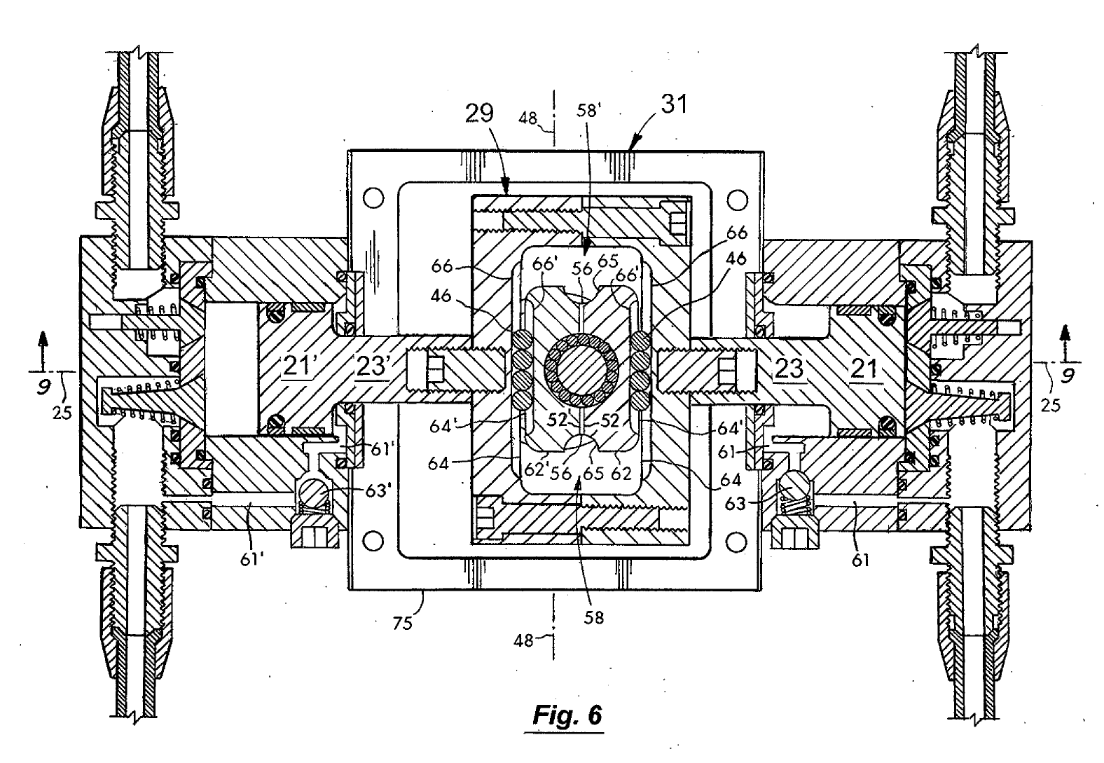

The reciprocating piston rods 23,23′ move the respective piston heads 21,21′ along the common fixed axis 25 relative to the cylinder end walls 37,37′ between first and second positions. The piston heads 21,21′ in this regard oppose one another and are operated 180 degrees out of phase with each other. More specifically, as the piston 21 of FIG. 4 for example is moved to its first position (see FIG. 5), the volume of the chamber 49 is expanded to receive refrigerant from the refrigeration system 2 of FIG. 2 through the common line 6 (FIGS. 2 and 3) and incoming line 7. At the same time, the opposing piston head 21′ is being moved to its second position of FIG. 5 to contract the volume of the chamber 49′ of FIG. 4 to drive the refrigerant out of the chamber 49′ into line 15′. The process is then reversed to move the aligned piston heads 21,21′ to the position of FIG. 6. In the contracted position of each piston head (e.g., see 21′ in FIG. 5), the substantially parallel piston surface 4T and the end wall 37′ of FIG. 4 preferably abut and are flush with one another for maximum compression (e.g., 300:1 or more). As shown in FIGS. 4-6, the piston heads 21,21′ and piston rods 23,23′ during their movement between the respective first and second positions are constrained to move symmetrically along the common fixed axis 25.

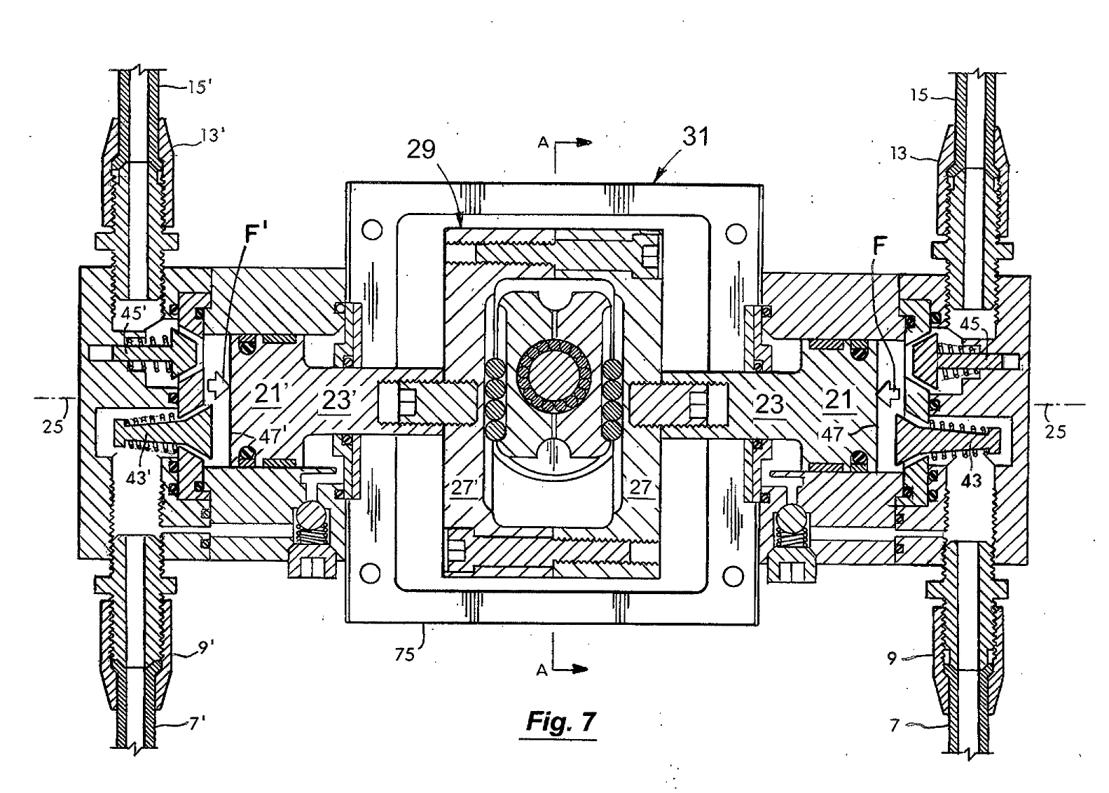

In operation, the refrigerant in the refrigeration system 2 to be recovered is normally at an initial pressure above atmospheric. In most cases, the pressure of the refrigerant will be well above atmospheric (100-300 psi or more). In contrast, the initial pressure in the storage tank 4 can vary from below atmospheric to above atmospheric depending upon how nearly empty or full the tank 4 is. As for example, the storage tank 4 prior to the start of a recovery operation may have been evacuated below atmospheric to remove air so as not to contaminate the refrigerant to be recovered. On the other hand and if the storage tank 4 is partially full (e.g., from a previous operation), the tank 4 may be at a pressure above atmospheric or even above the pressure of the refrigerant to be recovered from the refrigeration system 2 of FIG. 2. To the extent the initial pressure of the storage tank 4 is above the initial pressure of the refrigeration system 2, the outlet valves 45,45′ of the chambers 49,49′ in FIG. 4 will remain closed. However, to the extend the initial pressure of the storage tank 4 at hookup is below the pressure of the refrigerant in the refrigeration system 2, both pairs of inlet and outlet valves 43,45 and 43′,45′ will be opened as shown in FIG. 7. Refrigerant will then flow uninhibited from the refrigeration system 2 to the storage tank 4 until the pressures equalize and the valves 43,43′,45,45′ close.

Thereafter, the operation of the compressor 11 of the recovery unit 1 as illustrated in FIGS. 4-6 will be needed to transfer refrigerant from the refrigeration system 2 to the storage tank 4.

During the initial cycles of operation of the compressor 11 as indicated above, the refrigerant in the refrigeration system 2 normally is still above atmospheric. In most cases as also previously discussed, the incoming refrigerant will be well above atmospheric (e.g., 100-300 psi or more). Such high pressures if not properly handled can easily generate forces great enough to damage the components of the compressor 11 and lead to premature failure. In particular and if not properly handled, the initial force at hookup may even be high enough to overpower the driving mechanism of the compressor to the point that it cannot be started. To prevent this as explained in more detail below, the piston heads 21,21′ of the present invention are mounted in an opposing configuration wherein the forces generated on them by the incoming, pressurized refrigerant are counterbalanced or neutralized. Start up problems are essentially eliminated and any damage and wear due to the high forces of the pressurized refrigerant during the initial cycles of operation are greatly reduced.

More specifically and looking first at only the half of FIG. 7 to the right of line A-A, the incoming refrigerant in line 7 of FIG. 7 is normally at pressures well above atmospheric (e.g., up to 100-300 psi or more). Such pressures will open the inlet valve 43 and instantaneously exert a force F on the outer surface 47 of the piston head 21. This force F can be very significant and remain so during the initial cycles of the recovery operation until the pressure of the incoming refrigerant is greatly reduced (e.g., to 50-75 psi or lower). The initial size of the force F as discussed above may even be high enough to overpower the drive mechanism of the compressor 11 (were only the right piston head 21 and piston rod 23 of FIG. 7 present) and prevent the compressor 11 from starting. Initially and until the pressure of the incoming refrigerant in such a design is significantly reduced, the applied force F (which may even be exerted in impulses or jolts) on the piston head 21, piston rod 23, and the drive mechanism for the compressor 11 could easily lead to premature wearing and even failure. This is particularly true if the high pressure refrigerant is in a liquid phase. Eventually, the size of the force F would be reduced with each cycle of the piston head 21 as the pressure of the incoming refrigerant falls and the refrigerant is in a gas or vapor phase. However, until the refrigerant pressure (regardless of phase) in such a design is significantly reduced (e.g., to 50-75 psi or lower), each force F during each reciprocating cycle of the piston head 21 could damage and strain the components of the compressor 11. Again, this is describing the case were only the right piston head 21 and piston rod 23 of FIG. 7 present. However, in the preferred embodiment, the previously unbalanced force F on the piston head 21 on the right half of FIG. 7 at the outset and subsequent cyclic operation of the recovery unit 1 is counterbalanced or neutralized by an opposing force F′ on the opposite piston head 21′. The potentially damaging effect of the incoming force F is thereby essentially eliminated. This is particularly true because the intermediate structure including the piston heads 21,21′ and piston rods 23,23′ are axially aligned along 25 and rigidly attached to one another. Further, the drive mechanism for the compressor 11 only needs to then provide a differential force D (see FIG. 4) to reciprocate the piston heads 21,21′ to compress the refrigerant in the respective chambers 49,49′ and drive the refrigerant into the storage tank 4. In doing so, the drive mechanism of the compressor 11 does not have to overcome or compensate for the forces F,F′ on the piston heads 21,21′ in FIG. 7 as they counterbalance or neutralize one another. The drive mechanism for the compressor 11 can thus be designed to provide a maximum pressure (e.g., 550 psi or more in the chambers 49,49′) without having to consider or compensate for any effects of the incoming, refrigerant forces F,F′. In most cases, the compressor 11 can actually generate much higher pressures (750-1500 psi or more) but the operation of the unit 1 is normally limited to a lower pressure (e.g., 550 psi) for safety to protect the storage tank 4.

The isolation of the drive mechanism from the forces F,F′ is particularly important because the operating fluid as discussed above is two phase refrigerant. Consequently and usually unpredictably, the incoming refrigerant at any time may change phases and widely vary the forces F,F on the piston heads 21,21′. However, due to the counterbalancing design of the present invention, the forces F,F′ at any such time on the piston heads 21,21′ are neutralized along the common axis 25. The drive mechanism for the compressor 11 is then essentially unaffected by the forces F,F′ and/or the conditions (e.g., pressure, temperature, phase) of the incoming refrigerant. The differential force D provided by the compressor 11 in FIG. 4 will therefore be enough to move the twin piston heads 21,21′ repeatedly through their cycles to transfer the refrigerant (regardless of its phase or state from the refrigeration system 2 to the storage tank 4.

Although the counterbalancing design of the preferred embodiment isolates the differential force D from the forces F,F′, the drive mechanism including the piston rods 23,23′ of the compressor 11 and the components of the scotch yoke arrangement 31 must still be fairly structurally substantial. This is the case because the forces F,F′ (particularly during the initial operational cycles of the unit 1) must still be borne by the opposing components of the compressor 11. This includes the axially aligned piston heads 21,21′ and piston rods 23,23′ as well as the yoke member 29 of the scotch yoke arrangement 31. In this regard, it is again noted that these aligned and opposed members are rigidly attached and fixed to one another. This further enhances their ability to carry large loads including from the forces F,F′ without the undue damage and wear that might occur were these components not aligned and fixed relative to each other and not constrained to move symmetrically along the common fixed axis 25.

In operation, the compressor 11 as shown in FIG. 4 provides the differential force D in a direction (e.g., to the left in FIG. 4) along the common fixed axis 25. Only the force D is illustrated in FIG. 4 for clarity because the opposing forces F,F of FIG. 7 as discussed above cancel one another out. However, in driving the compressor 11 to the left in FIG. 4, the differential force D does combine with the force F of the pressurized refrigerant on the piston head 21 in that same direction to create a second force (F+D). This second force is then greater than the opposing first force F′ on the opposing piston head 21′. The opposing piston head 21′ is thereby driven to the left in FIG. 4 toward its contracted position of FIG. 5.

Stated another way, the incoming refrigerant at pressures above atmospheric in the lines 7,7′ to the chambers 49,49′ exerts first, opposing forces F,F′ on the outer surfaces 47,47′ of the piston heads 21,21′. These opposing forces F,F′ are directed along the common fixed axis 25. During the operating cycle as for example when piston head 21 is moved from its contracted position of FIG. 6 back to its expanded position of FIG. 5, the differential force D supplied by the scotch yoke arrangement 31 adds to the force F on the piston head 21. This in turn serves to move the other piston head 21′ to its contracted position of FIG. 5. The cycle is then repeated and is largely independent of any changing conditions (pressure, temperature, phase) in the refrigerant or the forces F,F′.

To aid in maintaining the forces F,F′ essentially the same, the incoming lines 7,7′ as indicated above (FIG. 3) are in fluid communication with each other and with the refrigerant in the line 6 from the refrigeration system 2 of FIG. 2. In this manner and even though the pressure of the refrigerant varies over time, it will always be the same in the incoming lines 7,7′. Consequently, the inlet valves 43,43′ of the chambers 49,49′ upstream of the inlets 39,39′ are simultaneously and continuously exposed to the same refrigerant pressure. The opposing forces F,F′ generated by the incoming, pressurized refrigerant on the outer surfaces 47,47′ of the opposing piston heads 21,21′ are then essentially always the same. It is additionally noted that the outgoing lines 15,15′ in FIG. 2 downstream of the outlet valves 45,45′ in each chamber outlet 41,41′ are also in fluid communication with each other and the storage tank 4 through line 18.

In the counterbalancing design of the preferred embodiment, only the chambers 49,49′ and the flow paths to and from them are intended to be exposed to the refrigerant and its possible contaminants (e.g., oil, fine metal particles). In particular, the undersides or bottoms 51,51′ of the piston heads 21,21′ in FIG. 4 are preferably designed not to be exposed to the refrigerant as are the drive mechanism including the piston rods 23,23′ and the components of the scotch yoke arrangement 31. However, to the extent the undersides 51,51′of the piston heads 21,21′ and portions of the piston rods 23,23′ may be so exposed, a chamber 55,55′ is provided adjacent the respective piston undersides 51,51′ (see FIG. 4) to capture or collect any contaminants and direct them harmlessly back through the one-way exhaust lines 61,61′ into the incoming refrigerant lines 7,7′. Should any contaminants so collect in the chambers 55,55′, they are still isolated from reaching the more vulnerable components of the scotch yoke arrangement 31

More specifically, each piston head 21,21′ as indicated above and shown in FIG. 4 has an underside 51,51′ adjacent the piston rod 23,23′ attached to the piston head 21,21′. The piston undersides 51,51′ extend about the respective piston rods 23,23′ and outwardly of the common fixed axis 25. The recovery unit in turn includes second end walls at 53,53′ (FIG. 4) respectively opposing the undersides 51,51′ of the piston heads 21,21′. The second end walls 53,53′ and piston undersides 51,51′ along with the second side wall portions 57,57′ of the cylinders 33,33′ (FIG. 4) then define respective, annular second chambers 55,55′. Exhaust lines 61,61′ are then provided as shown in FIG. 4 to extend between the respective second chambers 55,55′ and the respective incoming refrigerant lines 7,7′. Each exhaust line 61,61′ has a one-way valve 63,63′ in it to restrict flow therethrough to one direction from the respective second chambers 55,55′ to the respective incoming lines 7,7′.

In operation, each reciprocating piston rod 23,23′ as discussed above moves the respective piston head 21,21′ along the common fixed axis 25 relative to the respective first end wall 37,37′ of the cylinder 33,33′ between first and second positions. In doing so, the volume of the first or working chambers 49,49′ are respectively expanded and contracted. Conversely, the volume of the second chambers 55,55′ are then respectively contracted and expanded. The one-way valves 63,63′ in turn in the respective exhaust lines 61,61′ are then opened as the volume of the respective second chamber 55,55′ contracts and closed as the volume of the respective second chamber 55,55′ expands (see FIGS. 5 and 6). In this manner and to the extent any refrigerant and/or contaminants collect in the chambers 55,55′, they will be captured and directed harmlessly back through the one-way exhaust lines 61,61′ into the incoming refrigerant lines 7,7′ and out the discharge lines 15,15′. The undesirable refrigerant and/or contaminants in this regard are positively pumped into the incoming lines 7,7′ as the pressure in the respective, contracting second chambers 55,55′ exceeds the line pressure of 7,7′. To aid in discharging these undesirable fluids and with the common fixed axis 25 extending substantially horizontally as in FIG. 4, the inlet to each exhaust line 61,61′ preferably extends as shown from each second chamber 55,55′ substantially at the lowest location of the second chamber 55,55′ relative to the common fixed axis 25. Gravity can then help in collecting and delivering the contaminants into the exhaust lines 61,61′ particularly at the start up of the recovery unit and during its operation. The flow through the exhaust lines 61,61′ also serves to reduce the pressure load on the piston rod seals 54,54′ in FIG. 4 to further ensure that no contaminants pass thereby and that the scotch yoke arrangement 31 remains isolated from any such exposure. In this regard, the second end walls 53,53′ of the second chambers 55,55′ (see FIG. 4) slidably and sealingly at 54,54′ receive the reciprocating piston rods 23,23′ therethrough. As discussed above, the piston rod seals at 54,54′ then aid in isolating the scotch yoke arrangement 31 from the second chambers 55,55′ and their contents. It is noted that the first and second side wall portions 35,57 and 35′,57′ of each cylinder 33,33′ in FIG. 4 are adjacent one another along the axis 25. These portions can be spaced from each other as shown or can overlap one another if desired. The piston undersides 51,51′ preferably have the same annular area and are preferably parallel to the respective outer piston surfaces 47,47′.

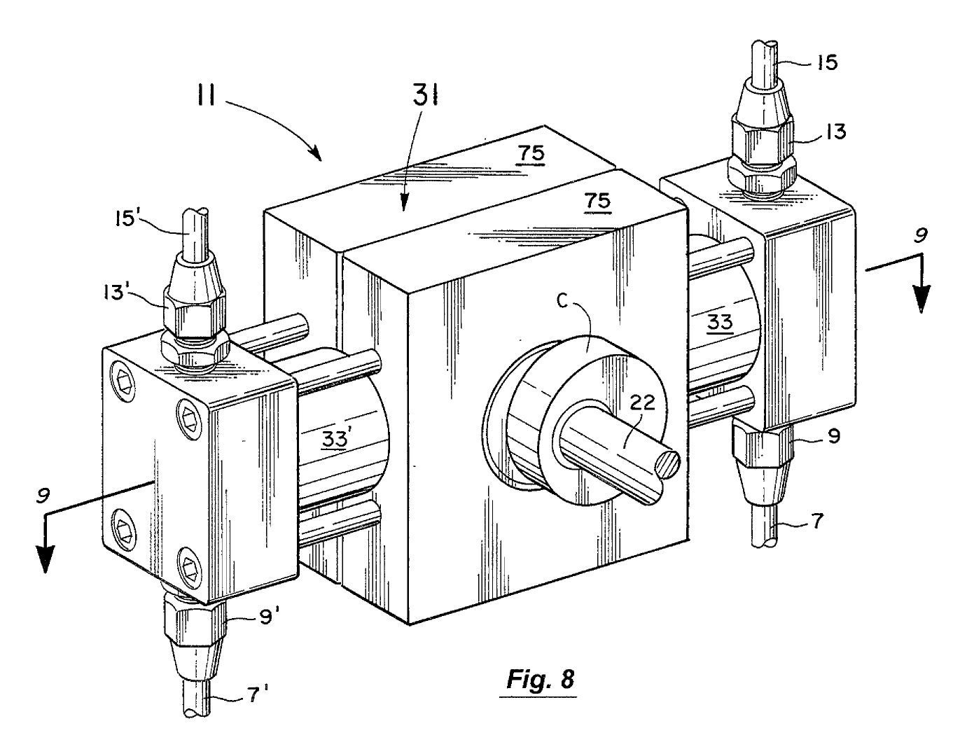

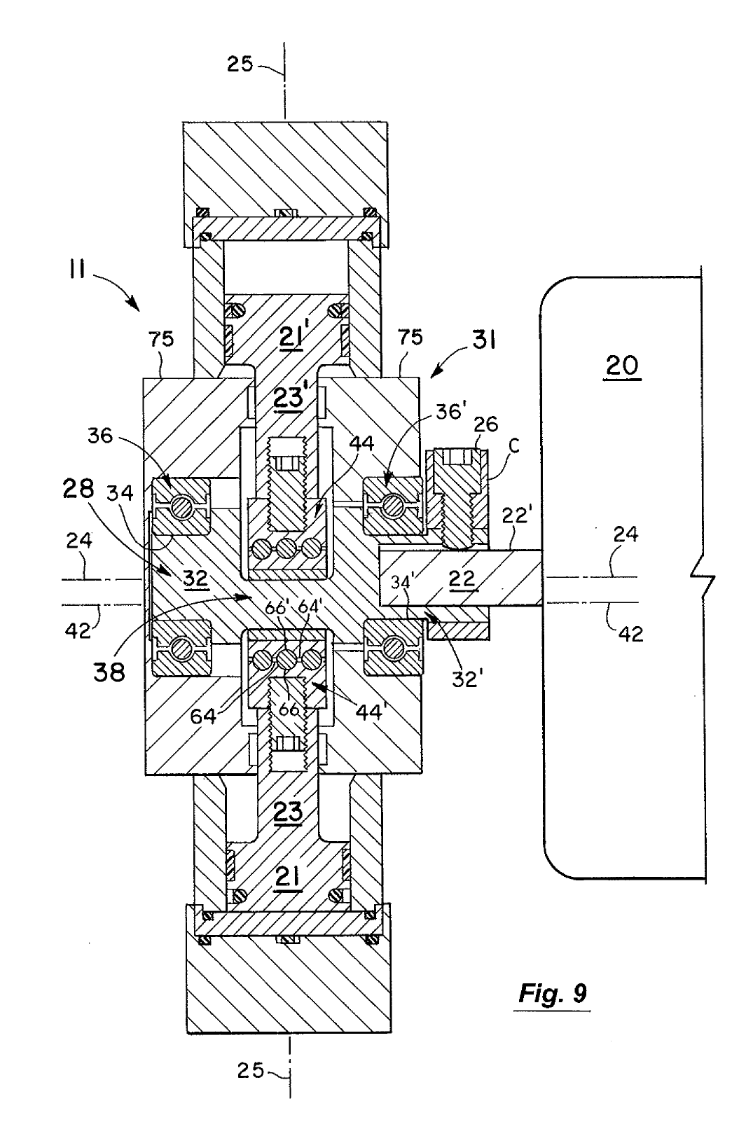

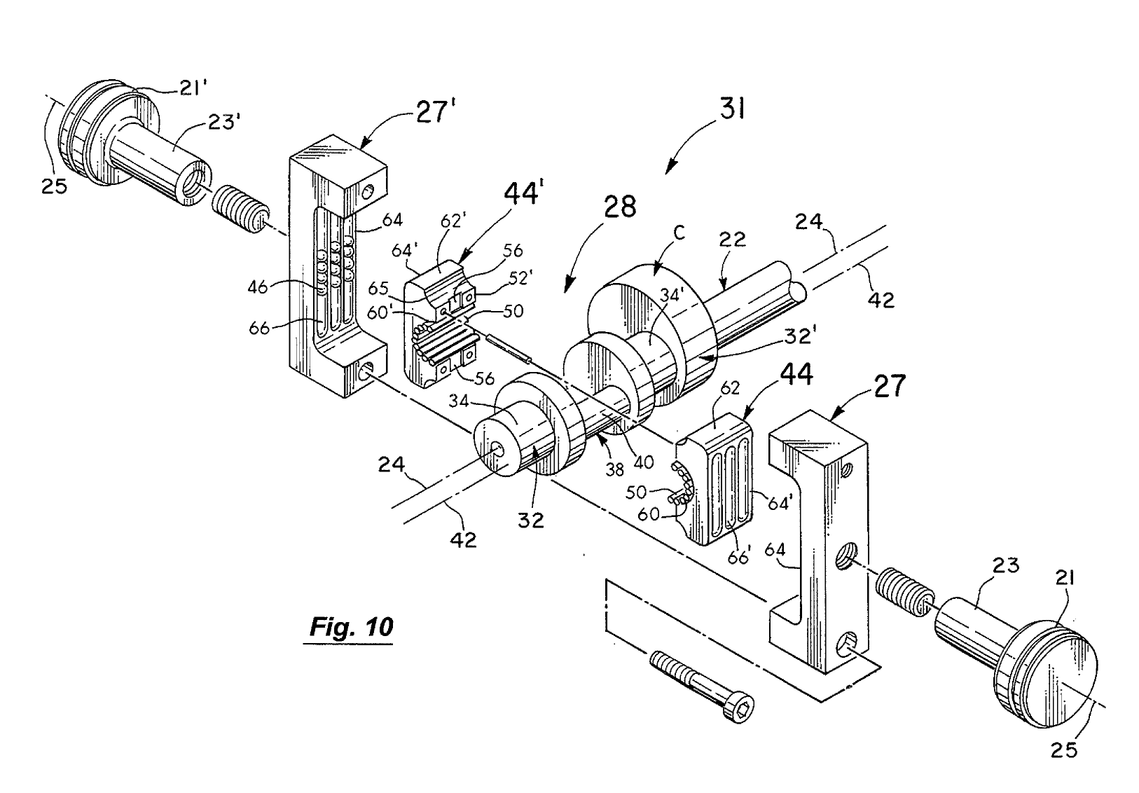

Referring to FIGS. 6 and 8-9, the drive mechanism for the compressor 11 includes the motor 20 (FIG. 9) which rotates the shaft 22 about the axis 24. The motor shaft 22 has a flattened upper portion 22′ and is attached adjacent the counterweight C (FIGS. 8-9) by a set screw 26 (see again FIG. 9) to the crankshaft 28 of the scotch yoke arrangement 31. The crankshaft 28 (see also FIG. 10) has spaced-apart bearing portions 32,32′ with cylindrical surfaces 34,34′ extending symmetrically about the rotational axis 24 within the race bearings 36,36′ of FIG. 9. A crank pin 38 (FIGS. 8-9) integrally extends between the bearing portions 32,32′ and has a cylindrical surface 40 extending along and about the axis 42. The circumference of each cylindrical surface 34,34′ about the axis 24 is substantially larger than the circumference of the cylindrical surface 40 about the axis 42. This is in contrast to many prior art designs in which the circumference of the crank pin or eccentric drive member is greater than the circumference of the adjacent bearing portion or portions.

In operation, the motor 20 (FIG. 9) rotates the motor shaft 22 and attached crankshaft 28 about the axis 24. This in turn rotates the crank pin 38 about the axis 24 with the axis 42 of the crank pin 38 also moving about the parallel axis 24. The rotating crank pin 38 in FIG. 9 is received within the two, opposing slide pieces 44 of the scotch yoke arrangement 31 (see also FIG. 5). The separate, slide pieces 44,44′ (FIG. 5) are confined and mounted by balls 46 to slidingly move relative to the yoke pieces 27,27′ along the vertical axis 48. The vertical axis 48 in the orientation of FIG. 5 passes symmetrically through the middle of the yoke member 29. In this manner and as the motor shaft 22 and crankshaft 28 are rotated about the axis 24 (FIG. 9), the offset crank pin 38 and its axis 42 are rotated about the axis 24.

The yoke side pieces 44,44′ of FIG. 5 are then moved up and down relative to the axis 48, which motion in turn reciprocally moves the yoke member 29 and attached piston rods 23,23′ and piston heads 21,21′ along the axis 25. The axes 24 and 42 of FIGS. 9 and 10 in this regard are substantially parallel to one another and substantially perpendicular to the axes 25 and 48 of FIG. 5. In this manner, the scotch yoke arrangement 31 thus translates rotation motion of the driving members 22, 28, and 38 about the axis 24 in FIG. 9 to reciprocal movement of the yoke member 29 and attached piston rods 23,23′ and piston heads 21,21′ along the axis 25 in FIG. 5. The slide pieces 44,44′ as shown in FIG. 5 abut one another about the crank pin 38 and needle bearing members or pins 50. In this regard, the abutting surfaces 52,52′ of the pieces 44,44′ are preferably substantially parallel to each other. Additionally, at least one of the surfaces 52,52′ in each abutting pair and preferably both surfaces 52,52′ have a groove 56 therein (see also FIG. 10). The groove 56 is in fluid communication with the areas 58,58′ (FIG. 5) above and below the slide pieces 44,44′. The needle bearings 50 about the crank pin 38 are confined as shown between the semi-cylindrical and inner facing surfaces 60,60′ of the pieces 44,44′. In this manner and as the pieces 44,44′ slidingly move along the axis 48 relative to the yoke member 29 in FIGS. 4-6, lubricant in the areas 58,58′ of FIG. 5 is forced or pumped through the grooves 56 to the needle bearings 50. The crankcase or yoke housing members 75 in this regard are substantially air tight to keep out dirt. This serves to enhance the pumping action on the lubricant as the volume of the areas 58,58′ are contracted. Additionally, the outer surfaces 62,62′ of the slide pieces 44,44′ adjoining the surfaces 52,52′ (see FIG. 6) have depressed or concave portions. These portions form respective pockets 65 as illustrated in FIG. 6 adjacent the entry to each groove 56 to collect lubricant.

The pieces 44,44′ of the sliding mechanism as discussed above are mounted to move up and down (in the orientation of FIGS. 5 and 6) along the axis 48 relative to the yoke member 29. The actual motion is along semi-circles extending along each side of axis 48. Although the abutting yoke side pieces 27,27′ as seen in FIG. 7 bear any large, opposing forces F,F that are generated by the pressurized refrigerant and isolate the slide pieces 44,44′ from the forces F,F′, the movement of the crank pin 38 in FIGS. 4-6 still generates significant forces on the yoke side pieces 27,27′. As for example, the compressor 11 may generate maximum pressures of 550 psi or more in the chambers 49,49′ driving the refrigerant out to the tank 4. To ameliorate or dissipate the high forces that can be generated between the driving slide pieces 44,44′ and driven yoke side pieces 27,27′, a plurality of rows of the balls 46 (FIGS. 6 and 10) are preferably provided. These balls 46 (see FIG. 6) are positioned between the inwardly and outwardly facing surfaces 64,64′ of the respective pairs of yoke 27,27′ and slide 44,44′ pieces (see also FIGS. 9 and 10). Each surface 64,64′ preferably has at least two grooves or tracks 66,66′ (FIGS. 9 and 10) extending substantially perpendicular to the axis 25 of FIG. 6 with the balls 46 positioned therein. The driving force D of each slide piece 44,44′ is then spread over more contact points between the surfaces 64,64′ to reduce potential wear and damage. The plurality of balls 46 and tracks 66,66′ also helps to maintain the alignment of the driving side pieces 44,44′ and driven yoke member 29.

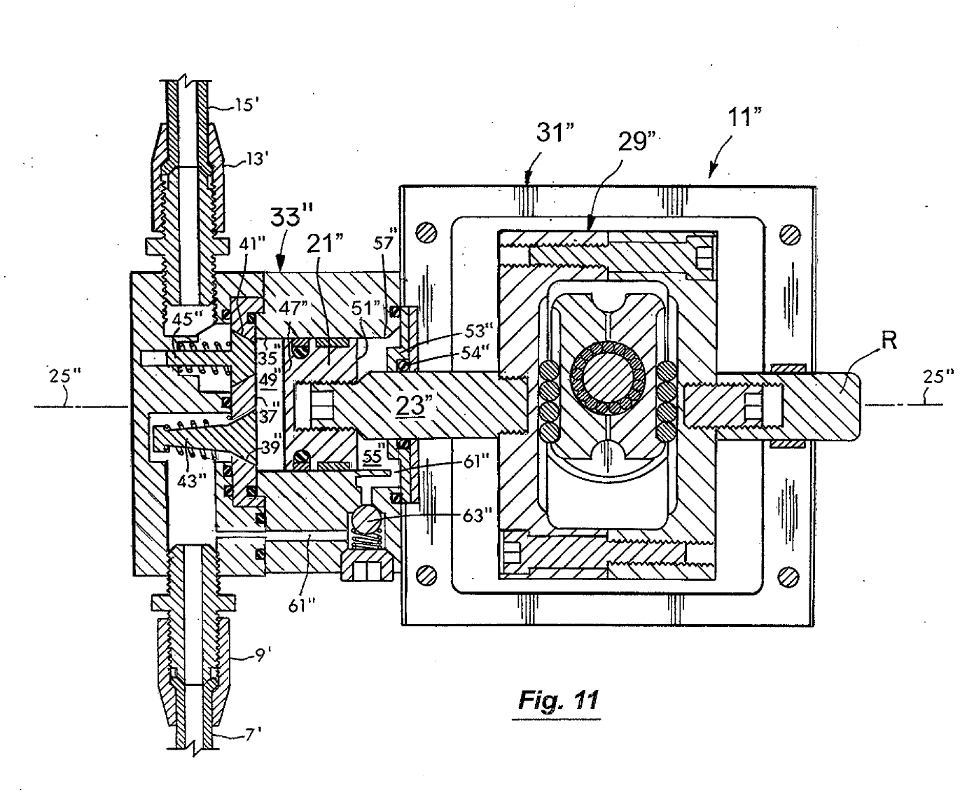

In FIG. 11, a single piston 21″ embodiment is shown which is driven by essentially the same scotch yoke arrangement 31″ as 31 in the earlier embodiments. As in the earlier embodiments, the under surface 51″ of the piston head 21″ adjacent the piston rod 23″ extends outwardly of and about the fixed axis 25″ as shown in FIG. 11. The stub or rod R on the other side of the yoke member 29″ in FIG. 11 is rigidly attached to the yoke member 29″ and the movement of the rod

R like that of piston rod 23″ and piston head 21″ is confined to along only the fixed axis 25″. This is in a manner corresponding to the earlier, twin embodiments. Similarly, the piston head 21″, piston rod 23″, and yoke member 29″ of FIG. 11 are rigidly attached to one another.

The embodiment of FIG. 11 like the earlier ones is provided with a corresponding first chamber 49″ within the cylinder 33″ defined by a first side wall portion 35″ of the cylinder 33″, a first end wall 37″ of the cylinder 33″, and the outer piston surface 47″. The embodiment of FIG. 11 then has a second chamber 55″ defined by the underside 51″ of the piston head 21″, the second side wall portion 57″ of the cylinder 33, and the second end wall 53″. An exhaust line 61″ is then provided as shown in FIG. 11 to extend between the second chamber 55″' and the incoming refrigerant line 7′. The exhaust line 61″ has a one-way valve 63″ in it to restrict flow therethrough to one direction from the second chamber 55″ to the incoming line 7′. In operation, the reciprocating piston rod 23″ like the earlier embodiments moves the piston head 21″ along the fixed axis 25″ relative to the first end wall 37″ of the cylinder 33″ between first and second positions. In doing so, the volume of the first or working chamber 49″ is expanded and contracted. Conversely, the volume of the second chamber 55″ is then contracted and expanded. The one-way valve 63″ in turn in the exhaust line 61″ is opened as the volume of the second chamber 55″ contracts and closed as the volume of the second chamber 55″ expands in the manner of FIGS. 5 and 6. Consequently and to the extent any refrigerant and/or contaminants collect in the chamber 55″, they will be captured and directed harmlessly back through the one-way exhaust line 61″ into the incoming refrigerant line 7′ and out the discharge line 15′. The undesirable refrigerant and/or contaminants in this regard like the earlier embodiments are positively pumped into the incoming line 7′ as the pressure in the contracting second chamber 55′″ exceeds the line pressure of 7′.

To aid in discharging these undesirable fluids and with the fixed axis 25″ extending substantially horizontally as in FIG. 11, the inlet to the exhaust line 61″ preferably extends as shown from the second chamber 55″ substantially at the lowest location of the second chamber 55″ relative to the fixed axis 25″. Gravity as in the earlier embodiments can then help in collecting and delivering the contaminants into the exhaust line 61″ particularly at the start up of the recovery unit and during its operation. The flow through the exhaust line 61″ also serves to reduce the pressure load on the piston rod seal 54″ in FIG. 11 to further ensure that no contaminants pass thereby and that the scotch yoke arrangement 31″ remains isolated from any such exposure. In this regard as in the earlier embodiments, the second end wall 53″ of the second chamber 55″ slidably and sealingly at 54″ receives the reciprocating piston rod 23″ therethrough. As discussed above, the piston rod seal at 54″ then aids in isolating the scotch yoke arrangement 31 from the second chamber 55″ and its contents. It is noted that the first and second side wall portions 35″ and 57″ of the cylinder 33″ as in the earlier embodiments are adjacent one another along the axis 25″. These portions can be spaced from each other as shown or can overlap one another if desired. The piston underside 51″ is preferably parallel to the outer piston surface 47″. Flow through the single piston compressor 11″ of FIG. 11 is then past the valve 43″ in the first chamber inlet 39″ into the first chamber 49″ and out the valve 45″ in the first chamber outlet 41″. The operation of the scotch yoke arrangement 31″ as indicated above is essentially the same as in the earlier embodiments.

The above disclosure sets forth a number of embodiments of the present invention described in detail with respect to the accompanying drawings. Those skilled in this art will appreciate that various changes, modifications, other structural arrangements, and other embodiments could be practiced under the teachings of the present invention without departing from the scope of this invention as set forth in the following claims. In particular, it is noted that the word substantially is utilized herein to represent the inherent degree of uncertainty that may be attributed to any quantitative comparison, value, measurement or other representation. This term is also utilized herein to represent the degree by which a quantitative representation may vary from a stated reference without resulting in a change in the basic function of the subject matter involved.

We claim:

1. A portable, refrigerant recovery unit for transferring refrigerant from a refrigeration system to a storage tank, said recovery unit including:
first and second piston heads (21,21′) respectively rigidly attached to first and second piston rods (23,23′), said piston rods extending along a common fixed axis (25) and being respectively rigidly attached to a yoke member (29) of a scotch yoke arrangement (31) to extend in opposite directions along said common fixed axis (25), said scotch yoke arrangement (31) translating rotational motion of a driving member into reciprocal movement of said yoke member (29) and rigidly attached piston rods (23,23′) and piston heads (21,21′) along said common fixed axis (25),
each piston head being slidably and sealingly received in a cylinder (33,33′) having a first side wall portion (35,35′) and a first end wall (37,37′), said first end wall having an inlet (39,39′) and outlet (41,41′) therethrough with respective one-way valves (43,43′ and 45,45′) therein, each piston head having an outer surface (47,47′) opposing said first end wall to define a first chamber (49,49′) with said first end wall (37,37′) and said first side wall portion (35,35′) of said cylinder (33,33′),
said recovery unit further including incoming lines (7,7′) in fluid communication with each other and each inlet of each first chamber upstream of the valve in each inlet, said incoming lines additionally being in fluid communication with the refrigerant in said refrigeration system,
each reciprocating piston rod (23,23′) moving the respective piston head (21,21′) along said common fixed axis (25) relative to each first end wall (37,37′) between first and second positions to respectively expand the volume of the first chamber (49,49′) to receive refrigerant from said refrigeration system into said first chamber and to contract the volume of the first chamber to drive said refrigerant out of said first chamber, each piston head being in the respective first and second positions when the other piston head is in the respective second and first positions wherein any opposing forces (F,F′) exerted by the refrigerant on the respective outer surfaces (47,47′) of the piston heads (21,21′) along the common fixed axis (25) counterbalance one another, each piston head (21,21′) further having an underside (51,51) adjacent the piston rod (23,23′) attached to the piston head (21,21′) and extending about the piston rod and outwardly of the common fixed axis (25), said recovery unit further including second end walls (53,53′) respectively opposing the undersides (51,51′) of the respective piston heads (21,21′) to define a respective second chamber (55,55′) with the respective underside (51,51′) and a respective second side wall portion (57,57′) of the respective cylinder (33,33′), each piston rod (23,23′) being respectively slidably and sealingly received in the respective second end wall (53,53′), said recovery unit further having a respective exhaust line (61,61′) extending between the respective second chamber (55,55′) and the respective incoming line (7,7′), each exhaust line (61,61′) having a one-way valve (63,63′) therein to restrict flow through the respective exhaust line (61,61′) to one direction from the respective second chamber (55,55′) to the respective incoming line (7,7′) wherein each reciprocating piston rod (23,23′) moves the respective piston head (21,21′) along the common fixed axis (25) relative to the respective first end wall (37,37′) of the respective cylinder (33,33′) between said first and second positions to respectively contract and expand the volume of the respective second chamber (55,55′), said one-way valve (63,63′) in said respective exhaust line (61,61′) being opened as the volume of the respective second chamber (55,55′) contracts and closed as the volume of the respective second chamber (55,55′) expands.

2. The recovery unit of claim 1 wherein the outer surfaces (47,47′) of the piston heads (21,21′) and the respective undersides (51,51′) of the piston heads (21,21′) are substantially parallel to each other.

3. The recovery unit of claim 1 wherein the first and second side wall portions (35,57 and 35′,57′) of the respective cylinders (33,33′) are substantially adjacent one another along said common fixed axis (25).

4. The recovery unit of claim 1 wherein the first and second side wall portions (35,57 and 35′,57′) of the respective cylinders (33,33′) are spaced from one another along said common fixed axis (25).

5. The recovery unit of claim 1 wherein the common fixed axis (25) extends substantially horizontally and each respective exhaust line (61,61′) has an inlet extending from the respective second chamber (55,55′) substantially at the lowest location of the respective second chamber (55,55′) relative to the common fixed axis (25).

6. The recovery unit of claim 1 wherein the outer surfaces (47,47′) of said piston heads (21,21′) have substantially the same area and the undersides (51,51′) of said piston heads (21,21′) have substantially the same area.

7. The recovery unit of claim 1 wherein said refrigerant in said incoming lines (7,7′) is above atmospheric pressure.

8. The recovery unit of claim 7 wherein said scotch yoke arrangement is isolated from exposure to said second chambers (55,55′) and said refrigerant.

9. The recovery unit of claim 1 wherein the pressure of the refrigerant in the incoming lines (7,7′) is the same and the inlet valves (43,43¹) of said first chambers (49,49′) upstream of the inlets are simultaneously and continuously exposed to said same pressure.

10. The recovery unit of claim 1 wherein the pressure of the refrigerant in the incoming lines (7,7′) varies over time and the inlet valves (43,43¹) of said first chambers (49,49′) upstream of the inlets are simultaneously and continuously exposed to said varying refrigerant pressure.

11. The recovery unit of claim 1 wherein the respective first end walls (37,37′) and outer surfaces (47,47′) of the piston heads (21,21′) are substantially planar and substantially parallel to each other.

12. The recovery unit of claim 11 wherein the respective first end wall and outer surface of each piston head are substantially flush with each other in the respective second position of said piston head.

13. The recovery unit of claim 1 further including outgoing lines (15,15′) in respective fluid communication with each other downstream of the valve (45,45′) in each outlet (41,41′) of each first chamber (49,49′), said outgoing lines (15,15′) additionally being in fluid communication with said storage tank (4).

14. The recovery unit of claim 1 wherein the rotational motion of said driving member is about an axis (24) substantially perpendicular to the common fixed axis (25).

15. A portable, refrigerant recovery unit for transferring refrigerant from a refrigeration system to a storage tank, said recovery unit including:
at least one piston head rigidly attached to a piston rod, said piston rod extending along a fixed axis and being rigidly attached to a yoke member of a scotch yoke arrangement, said scotch yoke arrangement translating rotational motion of a driving member into reciprocal movement of said yoke member and rigidly attached piston rod and piston head along said fixed axis,
said piston head being slidably and sealingly received in a cylinder having a first side wall portion and a first end wall, said first end wall having an inlet and outlet therethrough with respective one-way valves therein, said piston head having an outer surface opposing said first end wall to define a first chamber with said first end wall and said first side wall portion of said cylinder,
said recovery unit further including at least one incoming line in fluid communication with said inlet of said first chamber upstream of the valve in said inlet, said incoming line additionally being in fluid communication with the refrigerant in said refrigeration system,
said reciprocating piston rod moving the piston head along said fixed axis relative to said first end wall between first and second positions to respectively expand the volume of the first chamber to receive refrigerant from said refrigeration system into said first chamber and to contract the volume of the first chamber to drive said refrigerant out of said first chamber,
said piston head further having an underside adjacent the piston rod attached to the piston head and extending about the piston rod and outwardly of the fixed axis, said recovery unit further including a second end wall opposing the underside of the piston head to define a second chamber with the underside and a second side wall portion of the cylinder, said piston rod being slidably and sealingly received in the second end wall,
said recovery unit further having at least one exhaust line extending between the second chamber and the incoming line, said exhaust line having a one-way valve therein to restrict flow through the exhaust line to one direction from the second chamber to the incoming line wherein said reciprocating piston rod moves the piston head along the fixed axis relative to the first end wall of the cylinder between said first and second positions to contract and expand the volume of the second chamber, said one-way valve in said exhaust line being opened as the volume of the second chamber contracts and closed as the volume of the respective second chamber expands.

16. The recovery unit of claim 15 wherein the outer surface of the piston head and the underside of the piston head are substantially parallel to each other.

17. The recovery unit of claim 15 wherein the first and second side wall portions of the cylinder are substantially adjacent one another along said fixed axis.

18. The recovery unit of claim 15 wherein the first and second side wall portions of the cylinder are spaced from one another along said fixed axis.

19. The recovery unit of claim 15 wherein the fixed axis extends substantially horizontally and said exhaust line has an inlet extending from the second chamber substantially at the lowest location of the second chamber relative to the fixed axis.

20. The recovery unit of claim 15 wherein said refrigerant in said incoming line is above atmospheric pressure.

21. The recovery unit of claim 20 wherein said scotch yoke arrangement is isolated from exposure to said second chamber and said refrigerant.

22. The recovery unit of claim 15 wherein the first end wall and outer surface of the piston head are substantially planar and substantially parallel to each other.

23. The recovery unit of claim 22 wherein the first end wall and outer surface of said piston head are substantially flush with each other in the second position of said piston head.

24. The recovery unit of claim 15 wherein the rotational motion of said driving member is about an axis substantially perpendicular to the fixed axis.

25. The recovery unit of claim 15 wherein the recovery unit has only one piston head and one piston rod.
